(19) United States
(12) Patent Application Publication
(10) Pub. No.: US 2003/0053231 A1
(43) Pub. Date: Mar. 20, 2003

(54) Thermally actuated microelectromechanical tilt mirror

(76) Inventors: Mark Missey, Santa Clara, CA (US); Bardia Pezeshki, Redwood City, CA (US)

Correspondence Address: Finnegan Henderson Farabow, Garrett & Dunner LLP, 1300 I Street NW, Washington, DC, 20005-3315, US

(21) Appl. No.: 09/955,465

(22) Filed: Sep. 17, 2001

(51) Int. Cl. G02B 26/08; G02B 7/182

(52) U.S. Cl. 359/872; 359/876; 359/224

(57) ABSTRACT

A microelectromechanical tilt mirror includes a mirror lying in a first plane and a plurality of torsion bars. First and second chevrons are connected to the mirror by the torsion bars. The first and second chevrons are thermal actuators that tilt the mirror in a first direction relative to the first plane. The mirror, the torsion bars and the first and second chevrons are defined in a semiconductor layer. The mirror has a reflective layer formed on one side thereof. The first chevron includes first and second in-plane actuators located at opposite ends of a first out-of-plane actuator. The microelectromechanical mirror includes an orthogonal surface defined in the semiconductor layer. First and second orthogonal torsion bars connect the orthogonal surface to a third edge of the mirror. The microelectromechanical mirror allows tilting in one axis or more than one axis.

### FIELD OF THE INVENTION

The present invention relates to microelectromechanical tilt mirrors, and more particularly to thermally actuated microelectromechanical tilt mirrors.

### BACKGROUND OF THE INVENTION

Microelectromechanical (MEMS) tilt mirrors are fundamental components that enable many optical telecommunications solutions. Conventional MEMS tilt mirrors are typically implemented using electrostatic actuation. Electrostatic MEMS mirror arrays are commonly used for 3-D optical cross connects in optical routers and large switches (1000×1000) that are currently available from Lucent and Nortel. These electrostatic MEMS mirror arrays are typically fabricated using standard silicon micromachining processes. Therefore they are easier to produce than other micromachined mirror devices such as the aluminum-based MEMS mirror arrays produced by Texas Instruments and Astarte.

Lucent and AT&T have also investigated 2-D pop-up mirror arrays for smaller optical cross connects (e.g. 32×32). Ioλon is also using a MEMS mirror array in a tunable laser. Other applications employing MEMS mirror arrays include add-drop multiplexers, gain equalizers, and variable optical attenuators.

Conventional MEMS tilt mirrors are tilted by electrostatic actuation and are typically fabricated in either bulk single crystal silicon or in thin layers of polysilicon. Electrostatic actuation is a preferred method when power consumption is important. For example, large switching arrays using electrostatic actuation typically require very little power (<<1 mW/mirror). Electrostatic actuation is also well-suited for scanning mirror arrays since the rotation speed is limited by the mechanical response of the mirror.

There are several disadvantages when using electrostatic actuation for mirror movement or rotation. For moderate rotation angles such as 2°, large mirror surfaces (1 mm) require a relatively large separation distance between the mirror and the electrode. Typically the separation must be between 20-50 μm. For surface micromachining, complicated lifting structures must be fabricated to elevate the mirror above the surface by the desired distance. For bulk micromachining, a second wafer must be bonded to the first. In addition to fabrication complexity, the large separation distance weakens the electrostatic force that moves the mirror. Consequently, large operating voltages (50-100V) and very weak torsion bars are required. Although normally robust when acted upon by weaker electrostatic forces and very low mirror weight under normal operating conditions, the weak torsion bars break easily during fabrication when they are subjected to macro forces and vibrations. These structures are also highly sensitive to environmental effects.

Movement of electrostatic MEMS tilt mirrors depends nonlinearly on applied voltage. As a result, electrostatic MEMS tilt mirrors exhibit unstable behavior at a critical angle. Electrostatic force on the mirror is inversely proportional to the mirror-electrode separation distance. Therefore, there is a nonlinear relationship between force and rotation. In contrast, the torsion bars have a restoring force that is linear with rotation. The rate of increase in the electrostatic force with increasing rotation (decreasing mirror-electrode separation) is larger than the rate of increase of the restoring force provided by the torsion bars. At a “snap through” angle, the mirror rotation rapidly increases until the mirror contacts the electrode and a short-circuit occurs. The nonlinear response and instability complicates the electronic control of electrostatic MEMS tilt mirrors.

### SUMMARY OF THE INVENTION

A microelectromechanical tilt mirror according to the invention includes a mirror lying in a first plane. A first chevron is connected to the mirror. A second chevron is connected to the mirror. The first and second chevrons are thermal actuators that tilt the mirror in a first direction relative to the first plane.

In other features of the invention, the mirror is connected to the first and second chevrons using a plurality of torsion bars. The mirror, the torsion bars and the first and second chevrons are defined in a first semiconductor layer. The mirror has a reflective layer formed on one side thereof.

In still other features of the invention, the first chevron includes first and second in-plane actuators located at opposite ends of a first out-of-plane actuator. First and second torsion bars attach the first chevron to one edge of the mirror. Third and fourth torsion bars attach the second chevron to the opposite edge of the mirror.

In still other features, the mirror is generally rectangular and the first and third torsion bars are attached on opposite edges of one end of the mirror. The second and fourth torsion bars are attached on opposite edges near a mid-portion of the mirror.

In yet other features, the microelectromechanical mirror includes an orthogonal surface defined in the semiconductor layer. First and second orthogonal torsion bars connect the orthogonal surface to a third edge of the mirror. The microelectromechanical mirrors allow rotation along one axis or more than one axis.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a thermally actuated MEMS mirror according to the present invention;

FIG. 2 is a perspective view of the thermally actuated MEMS mirror in both tilted and planar positions;

FIG. 3 is a plan view of an alternate thermally actuated MEMS mirror according to the present invention that includes an orthogonal torsion bar;

FIG. 4 is a perspective view of the alternate thermally actuated MEMS mirror of FIG. 3 in both tilted and planar positions;

FIG. 5 illustrates an exemplary structure that is used for fabricating the thermally actuated MEMS mirror;

FIG. 6 illustrates an in-plane thermal actuator;

FIG. 7 illustrates an out-of-plane thermal actuator;

FIG. 8 illustrates the thermally actuated MEMS mirror of FIGS. 1 and 2 in an exemplary 1×n optical switching device; and

FIG. 9 illustrates the thermally actuated MEMS mirror of FIGS. 3 and 4 in an exemplary n×m optical switching device.

### DETAILED DESCRIPTION OF THE PREFERRED EMBODIMENTS

The following description of the preferred embodiment(s) is merely exemplary in nature and is in no way intended to limit the invention, its application, or uses.

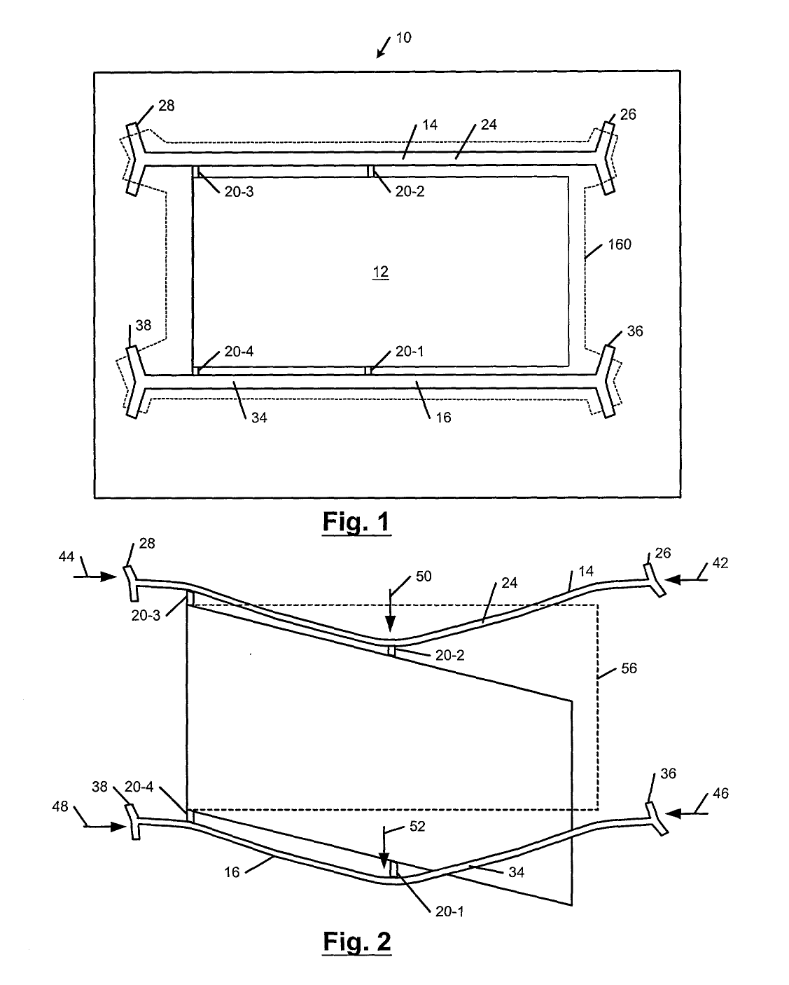

Referring now to FIGS. 1 and 2, a thermally actuated MEMS mirror system 10 according to the present invention is shown. The thermally actuated MEMS mirror system 10 includes a tilting mirror 12, a first chevron 14, a second chevron 16, and a plurality of torsion bars 20-1, 20-2, . . . 20-n. The torsion bars 20 connect the first and second chevrons 14 and 16 to opposite sides of the mirror 12. The moving components of the thermally actuated MEMS mirror system 10 are preferably fabricated from a single planar semiconductor layer as will be described further below.

The first chevron 14 preferably includes an out-of-plane actuator 24 and first and second in-plane actuators 26 and 28 that are located at opposite ends of the out-of-plane actuator 24. Likewise, the second chevron 16 preferably includes an out-of-plane actuator 34 and first and second in-plane actuators 36 and 38 that are located at opposite ends of the out-of-plane actuator 34. One or more conventional control circuits (not shown) are connected to the first and second chevrons 14 and 16. The control circuits generate a controlled and regulated current that passes through the first and second chevrons 14 and 16. As the first and second chevrons 14 and 16 heat and expand, the first and second chevrons 14 and 16 vary the tilt angle of the mirror 12. The first and second chevrons 14 and 16 are preferably doped with impurity ions to vary the resistance of the first and second chevrons 14 and 16.

The control circuit(s) apply approximately the same amount of current to the first and second chevrons 14 and 16. Alternately, a calibration step may be performed to determine the appropriate current level for each chevron 14 and 16 to obtain the desired rotation and orientation. The in-plane actuators 26, 28, 36, and 38 move in a direction indicated by arrows 42, 44, 46 and 48, respectively. Likewise, the out-of-plane actuators 24 and 34 move in a direction indicated by arrows 50 and 52, respectively. The torsion bars 20-1 and 20-2 are preferably located at a midportion of the mirror 12. The torsion bars 20-3 and 20-4 are preferably located at one end of the mirror 12. The movement of the in-plane actuators 26, 28, 36 and 38 and the out-of-plane actuators 24 and 34 tilts the mirror 12 from its original planar position indicated by dotted lines 56 to a tilted position shown in FIG. 2. The torsion bars 20 provide a restoring force to return the mirror 12 to the planar position. Skilled artisans will appreciate that the amount of movement of the mirror 12 can be altered by adjusting the positions of the torsion bars 20 relative to the mirror 12.

The thermally actuated MEMS mirror system according to the invention employs thermal actuators for tilting the MEMS mirror. Thermal actuators require relatively low voltages (typically between 1-5V) and moderate per element power (100-500 mW/mirror). Thermal actuators can provide relatively high force (1N) and displacement (up to 100 micrometers). Thermal actuators can be fabricated using a single step in-plane process. Thermal actuators provide a linear relationship between power and mirror motion and are therefore easier to control. The thermal actuators have a response time between 10-100 ms.

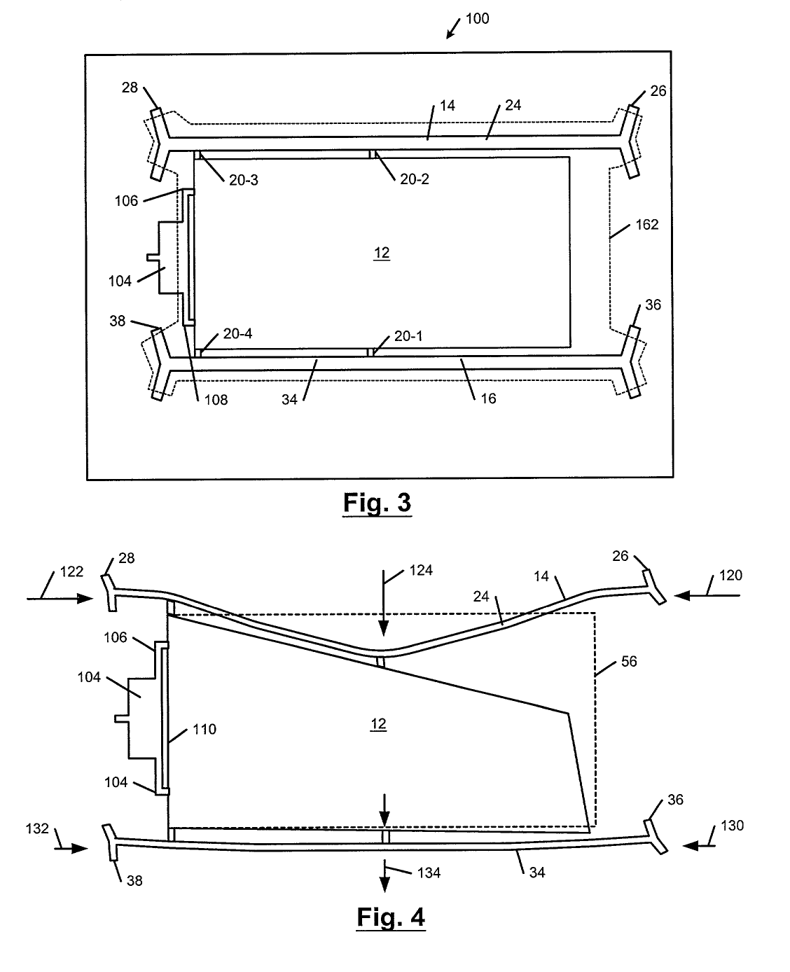

Referring now to FIGS. 3 and 4, an alternate thermally actuated MEMS mirror system 100 is shown. For purposes of clarity, reference numbers from FIGS. 1 and 2 have been used where appropriate to identify the same elements. The alternate thermally actuated MEMS mirror system 100 additionally includes an orthogonal surface 104 including first and second projecting torsion bars 106 and 108 that are connected in a spaced relationship to edge 110 of the mirror 12.

When the control circuit applies substantially different current levels to the first and second chevrons 14 and 16, the in-plane actuators 26 and 28 are displaced as indicated by arrows 120 and 122. The out-of-plane actuator 24 is displaced as is indicated by arrow 124. The in-plane actuators 36 and 38 are displaced to a lesser extent as indicated by arrows 130 and 132. The out-of-plane actuator 24 is displaced to a lesser extent as is indicated by arrow 134. The difference in the displacement is caused by different current levels in the first and second chevrons 14 and 16. The first and second chevrons 14 and 1b and the torsion bars 106 and 108 enable the mirror 12 to rotate in a multiple directions as compared with the system 10 that is shown in FIGS. 1 and 2.

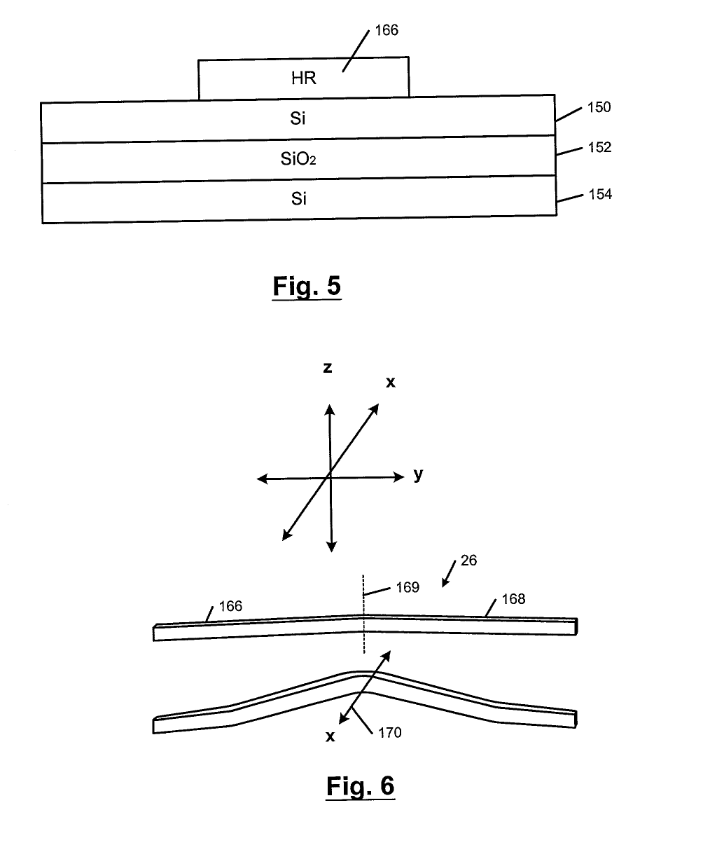

Referring now to FIG. 5, an exemplary method for fabricating the thermally actuated MEMS mirror systems 10 and 100 is shown. A silicon layer 150 having a desired thickness is bonded, grown or sputtered on a silicon on insulator (SOI) wafer including silicon dioxide (SiO₂) and silicon (Si) layers 152 and 154. A bottom side or top side etch is performed to release selected portions of the thermally actuated MEMS mirror systems 10 and 100. For example, the portions lying within the dotted lines 160 and 162 in FIGS. 1 and 3 are released while the portions outside the dotted lines 160 and 162 remain attached. After patterning, a highly reflective (HR) layer 166 is preferably formed on an outer surface of the mirror 12.

The thermally actuated mirrors can be fabricated using surface or bulk micromachining processes. The preferred method for fabricating the thermally actuated mirrors is the bulk micromachining process due to its inherent repeatability and fewer problems with surface micromachining. The thermally actuated mirror can be easily fabricated using bulk micromachining with silicon wafers or bulk micromachining with SOI wafers. In either case, the structure is formed by etching the front surface with a single masking step. A metalization step defines device contacts and can also be used to form the highly reflective (HR) layer on the mirror surface. The structure is then released by backside etching. When SOI micromachining is performed, a hydrofluoric (HF) dip is used to remove the SiO₂ layer. A second etching step on the front surface or a stressed film can be used to break the symmetry and cause buckling in a preferred direction.

Referring now to FIG. 6, the in-plane actuators 26 is shown in more detail. The in-plane actuator 26 moves in a plane defined by the x-y plane. The in-plane actuator 26 includes first and second beams 166 and 168 that are joined at dotted line 169 at a slight angle. The first and second beams 166 and 168 are preferably defined by standard photolithographic and etching techniques. The first and second beams 166 and 168 are preferably thicker in the out-of-plane direction than in the in-plane direction. When power is applied to the in-plane actuator 26, the first and second beams 166 and 168 heat and expand. The in-plane actuator 26 buckles out in a direction of the joint. The magnitude of the structural displacement depends on the power that is applied to the in-plane actuator 26 and does not depend on the ambient temperature. When the current is removed, the in-plane actuator 26 returns to its original position. The remaining in-plane actuators 28, 36 and 38 operate in a similar manner.

Referring now to FIG. 7, the out-of-plane actuator 24 is shown in further detail. As a result of the in-plane actuators 26 and 28 generating forces indicated by arrows 174 and 176, the out-of-plane actuator 24 moves in the z direction (indicated by arrow 178) which is out of the x-y plane. A plurality of notches 180 may be formed in the out-of-plane actuator 24 on a side opposite to the direction of intended movement to facilitate bending. The notches 180, however, are not required due to the presence of the in-plane actuators 26 and 28.

The out-of-plane actuator 24 cannot be made of two beams meeting at an angle because etching takes place in the z direction. To make the out-of-plane actuator 24 preferentially buckle in the out-of-plane direction, the actuator beams forming the out-of-plane actuator 24 are made much thicker in the in-plane direction than in the out-of-plane direction. Best performance is achieved when the actuator thickness out-of-plane is tapered linearly from the anchored ends to the center of the beam. This can be performed using sophisticated grayscale photoresist technology or by etching trenches of equal depth into the beam. Skilled artisans can appreciate that the first and second chevrons 14 and 16 may include out-of-plane actuators with notches or in-plane actuators in combination with out-of-plane actuators (with or without notches). When in-plane actuators are used in combination with out-of-plane actuators, the in-plane actuator motion of 3 micrometers is mechanically amplified into an out-of-plane displacement of 50 micrometers or more.

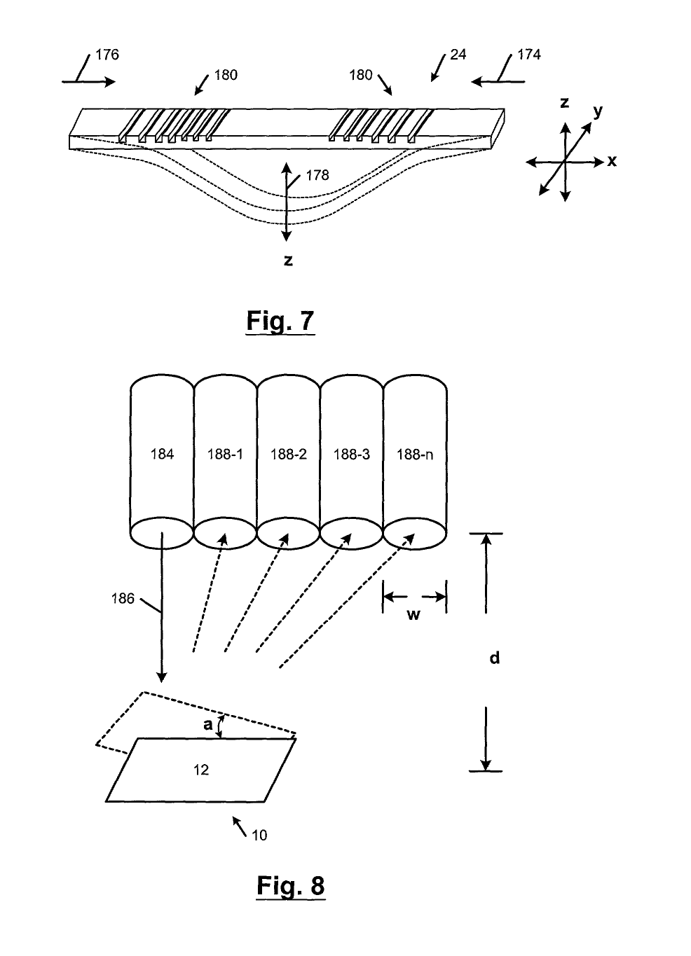

Referring now to FIG. 8, the thermally actuated tilt mirror system 10 is shown in an exemplary embodiment that provides 1×n switching. An input optical fiber 184 is positioned relative to the MEMS mirror system 10. The input optical fiber 184 directs an incoming beam of light 186 onto the mirror 12. The angle of the mirror 12 is varied using the MEMS mirror system 10 to reflect the incoming beam of light 186 onto one of n output optical fibers 188-1,188-2, 188-3, . . . , 188-n. As can be appreciated, the maximum number n of output optical fibers 188 is related to a width w of each optical fiber, the spacing between the optical fibers, the angle a, a distance d between the mirror 12 and the optical fibers, and other factors.

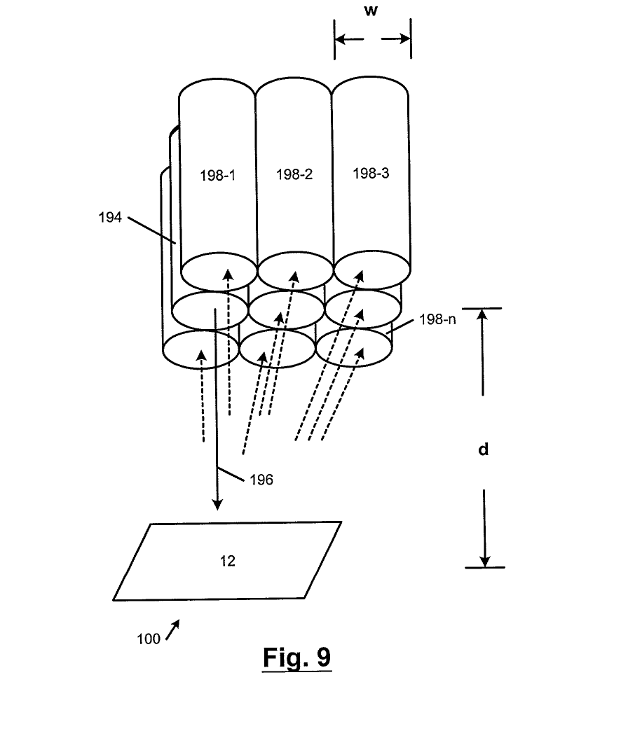

Referring now to FIG. 9, the thermally actuated tilt mirror system 100 is shown in an exemplary embodiment that provides n×m switching. An input optical fiber 194 is positioned relative to the tilt mirror system 100. The input optical fiber 194 directs an incoming beam of light 196 onto the mirror 12. The angle of the mirror 12 is varied using the system 100 to reflect the incoming beam of light 196 onto one of a plurality of n output optical fibers 198-1, 198-2, 198-3, . . . , 198-n. In contrast to the embodiment of FIG. 8, different or similar current levels are output to the first and second chevrons 14 and 16 depending upon the desired mirror angle. As can be appreciated, the maximum number n of output optical fibers 198 is similarly related to a width w of each optical fiber, the spacing between the optical fibers, the angle variation that is provided by the mirror 12, a distance d between the mirror 12 and the optical fibers, and other factors.

The coupled operation of the torsion bars and the thermal actuators require that these components be co-optimally designed. The width, thickness and length of the torsion bars determines the restoring force on the mirror. The various parameters of the thermal actuator determine maximum displacement and force that is available from the actuators. For the thermal actuators, there is a fundamental trade-off between displacement, force and operating power. As a result, greater mirror tilt angles are possible at reduced operating power as the torsion bars and actuators become very thin. However, the strength of the torsion bars and the thermal actuators decreases as they become very thin, which causes an additional trade-off between power and device ruggedness.

Typical power levels for in-plane and out-of-plane thermal actuators is on the order of 100 mW. Mirrors providing two degrees or more of tilt are possible. The thermal actuators advantageously require relatively low voltages (typically between 1-5V) and moderate per element power (100-500 mW/mirror). The thermal actuators can be fabricated using a single step in-plane process. The thermal actuators provide a linear relationship between power and mirror motion.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A microelectromechanical tilt mirror, comprising:
a mirror lying in a first plane;
a first chevron that is connected to said mirror; and
a second chevron that is connected to said mirror,
wherein said first and second chevrons are thermal actuators that tilt said mirror in a first direction relative to said first plane.

2. The microelectromechanical mirror of claim 1 further comprising a plurality of torsion bars that connect said mirror to said first and second chevrons.

3. The microelectromechanical mirror of claim 2 wherein said mirror, said torsion bars and said first and second chevrons are defined in a semiconductor layer.

4. The microelectromechanical mirror of claim 1 wherein said mirror has a reflective layer formed on one side thereof.

5. The microelectromechanical mirror of claim 3 wherein said semiconductor layer is silicon.

6. The microelectromechanical mirror of claim 1 wherein said mirror is generally rectangular and said first chevron extends along and is attached by first and second torsion bars to a first side of said mirror.

7. The microelectromechanical mirror of claim 6 wherein said first chevron further includes first and second in-plane actuators located at opposite ends of a first out-of-plane actuator.

8. The microelectromechanical mirror of claim 6 wherein third and fourth torsion bars attach said second chevron to a second side of said mirror.

9. The microelectromechanical mirror of claim 8 said first and third torsion bars are attached to one end of said mirror.

10. The microelectromechanical mirror of claim 9 wherein said second and fourth torsion bars are attached to mid-portion of said mirror.

11. The microelectromechanical mirror of claim 1 further comprising:
an orthogonal surface;
a pair of orthogonal torsion bars connecting said orthogonal surface to a third edge of said mirror.

12. The microelectromechanical mirror of claim 11 wherein said orthogonal surface is partially released from a substrate.

13. The microelectromechanical mirror of claim 7 wherein said first out-of-plane actuator is released from a substrate.

14. The microelectromechanical mirror of claim 13 wherein said first and second in-plane actuators are partially released from said substrate.

15. A microelectromechanical tilt mirror, comprising:
a semiconductor layer formed on a substrate;
a first surface formed in said semiconductor layer and lying in a first plane;
a plurality of torsion bars formed in said semiconductor layer;
a first chevron that is formed in said semiconductor layer and is connected to said mirror by a first torsion bar; and
a second chevron that is formed in said semiconductor layer and is connected to said mirror by a second torsion bar,
wherein said mirror and said torsion bars are released from said substrate and said first and second chevrons are at least partially released from said substrate, and wherein said first and second chevrons rotate said mirror relative to said first plane.

16. The microelectromechanical mirror of claim 15 further comprising a reflective coating formed on one side of said first surface.

17. The microelectromechanical mirror of claim 15 wherein said semiconductor layer is silicon.

18. The microelectromechanical mirror of claim 15 wherein said first chevron is a thermal actuator.

19. The microelectromechanical mirror of claim 18 wherein said first chevron includes first and second in-plane actuators located at opposite ends of a first out-of-plane actuator.

20. The microelectromechanical mirror of claim 15 further comprising a third torsion bar that attaches said first chevron to said mirror.

21. The microelectromechanical mirror of claim 20 further comprising a fourth torsion bar that attaches said second chevron to said mirror.

22. The microelectromechanical mirror of claim 21 wherein said mirror is generally rectangular and said first and second torsion bars are attached near one end of said mirror.

23. The microelectromechanical mirror of claim 22 wherein said third and fourth torsion bars are attached near a midportion of said mirror.

24. The microelectromechanical mirror of claim 15 further comprising:
an orthogonal surface;
first and second spaced orthogonal torsion bars connecting said orthogonal surface to said mirror.

25. The microelectromechanical mirror of claim 24 wherein said orthogonal surface is partially released from a substrate.

26. A method of fabricating a microelectromechanical tilt mirror comprising the steps of:
defining a mirror in a semiconductor layer;
defining a chevron in said semiconductor layer;
connecting said first chevron to said mirror;
defining a second chevron in said semiconductor layer;
connecting said second chevron to said mirror using a third torsion bar; and
tilting said mirror using said first and second chevrons.

27. The method of claim 26 wherein said semiconductor layer is silicon.

28. The method of claim 27 wherein said first and second chevrons are thermal actuators.

29. The method of claim 28 wherein said first chevron includes an out-of-plane actuator.

30. The method of claim 29 wherein said first chevron further includes first and second in-plane actuators located at opposite ends of said first out-of-plane actuator.

31. The method of claim 26 further comprising the step of attaching said first chevron to said mirror using a third torsion bar.

32. The method of claim 31 further comprising the step of attaching said second chevron to said mirror using a fourth torsion bar.

33. The method of claim 32 wherein said mirror is generally rectangular and said first and second torsion bars are attached near one end of said mirror.

34. The method of claim 33 wherein said third and fourth torsion bars are attached near a to midportion of said mirror.

35. The method of claim 26 further comprising the steps of:
forming an orthogonal surface that includes first and second spaced torsion beams in said semiconductor layer;
connecting said first and second torsion beams to said mirror.
